(19) United States
(12) Patent Application Publication
(10) Pub. No.: US 2008/0168606 A1
(43) Pub. Date: Jul. 17, 2008

(54) Product For Pelt Conditioning For Tanning: Process For Pelt Conditioning and Following Tanning

(76) Inventors: Renato Augusto Konrath, Novo Hamburgo/RS-Brasil (BR); Francisco Jose Fava, Porto Alegre/RS - Brasil (BR); Jose Everton Braun, Porto Alegre/RS-Brasil (BR)

Correspondence Address: OSTROLENK FABER GERB & SOFFEN, 1180 AVENUE OF THE AMERICAS, NEW YORK, NY, 100368403, US

(21) Appl. No.: 11/813,355

(22) PCT Filed: Feb. 21, 2006
(86) PCT No.: PCT/BR2006/000033

§ 371 Date: Jul. 5, 2007

(30) Foreign Application Priority Data
Feb. 22, 2005 (BR) PI05604-0

(51) Int. Cl. C14C 3/02; C14C 3/06; C14C 3/10; C14C 3/16; C14C 3/24; C14C 3/26

(52) U.S. Cl. 8/94.27; 8/94.29; 8/94.28; 8/94.19 R; 8/94.32; 8/94.33

(57) ABSTRACT

The present invention is related to the use of a new conditioning agent for treating pelts for tanning. This conditioning agent consists in a composition of modified aldehydes, carboxylic acids or polycarboxylic acids and additives. The conditioning agent is used for replacing the steps of deliming and pickling in the pelts treatment. The action of the product can eliminate the step of basification when the tanning is made with chromium salts. The objective of the present invention is the use of a novel composition that can replace the steps of deliming, step 6, and pickling, step 8, described before for one just step called conditioning The proposed system, neutralizes the alkalinity and hence removes the solubility of Calcium from the liming operation attached in the pelt. The system described is obtained from functional aldehydes with the general formulation as following: The system comprises functional aldehydes to which are added a combination or just one of the following chemicals: mono, di, tri and polycarboxilic acids; anhydrides: fumaric, maleic and ftalic anhydrides of dicarboxilic acids that contains at least 2 to 8 carbon atoms; esters of mono, di, tri and polycarboxilic acids; EDTA; boric acid and sodium and calcium tripolyphosphates As solvents to stabilize the system it is used one or a mixture of the following compounds: water, branched or non-branched aliphatic alcohol, glycols and polyols.

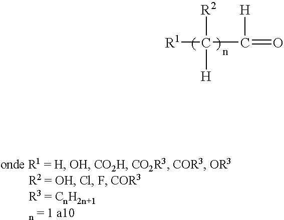

The present invention is related to the use of a new conditioning agent for treating pelts for tanning. This conditioning agent consists in a composition of modified aldehydes, carboxylic acids or polycarboxylic acids and aiders. The conditioning agent is used to replace the steps of deliming and picketing in the pelts treatment. The action of the product can eliminate the step of basification when the tanning is made with chromium salts.

The state of the art describes the process of treating animal pelts to transform into leather involving many steps. Transformation starts when the skin is removed from the animal and treated with chemicals that maintain its conservation. The following steps describe the preparation of pelts that come from slaughter houses prior of tanning. The steps are ordered after slaughter and conservation:

1. Washing to eliminate preservatives and other soluble materials off the pelts.

2. Pre-skinning (Scrapping the meat and fat);

3. Soak (soften up the tissues to make the fleshing process easier) 4. Dehairing and liming (alkaline step—pH=12.0-12.5, where hair and epidermis is scrapped );

5. Final skinning and split (elimination of remaining fats and reduction of thickness);

6. Deliming (neutralization of resulting alkalinity of prior step);

7. Bating (treatment with enzymes to remove undesirable proteins, dirt and fats. 8. Pickling (acid-salt treatment that improves the action of the tanning agent).

Steps from 1 to 8 are described as indispensable for tanning process whatever the tanning agent to be used. After the 8^{th} step the pelts are ready for tanning. Tanning will bring about special characteristics to the pelt as putrefication resistance, mechanical resistance, temperature resistance and others.

The state of the art describes the use of ammonium salts in step 6 (deliming) and sodium chloride and sulfuric and formic acid, in step 8 (pickling). Steps 6 and 8, deliming and pickling respectively, generate big volumes of pollutants that remain in aqueous solution as: sodium chloride, organic nitrogen, ammonia, acids, fats, sulfides and proteins. Toxic vapors and gases also are formed as ammonia, sulfides, formic acid vapors that contaminate the work area.

The pollution generated is a consequence of chemicals used in the referred steps. These chemicals provide hazardous environment and not safe working conditions to the ones involved in pelt processes. Other negative aspects related to use of these chemicals are:

1. Increase of occupational diseases due to the continuous exposition to toxic gases and vapors.

2. Increase of risk of serious or even life-threatening accidents due to sulfuric or formic burns;

3. Need of big control during handling of these products in the process;

4. In process generated pollutants as gases, aerosols, and vapors.

5. Heavy corrosion of machines and equipment due to high levels of sodium chloride and acids in leather to be processed;

The step 8, pickling pose risks to workers that manipulate strong acids as sulfuric and formic and to the process, due to their reactivity. In the case of those acids be added without correct previous dilution, or if they are added to fast, they can cause burning spots over pelt surface or cause acid hydrolysis in the proteins, damaging the leather.

The pelt turns out to be a very complex chemical reagent due to its protein composition. The technique describes alkalinity and acidity conditions as well as the products used during the transformation of pelt to leather. The reactivity of collagen protein, constituent of the pelts, is modified along the processing with added products. This modification is detectable by change in isoelectric point value of collagen and consequently its ionic charge. Tanning with inorganic products (chromium, aluminum, titanium, zirconium, iron, zinc, etc.), occurs rather by a chemical reaction with carboxylic groups of amino-acids that constitute the protein. The ionic character of the pelt after tanning with inorganic products turns cationic because of the presence of positive groups (amino groups) that has not reacted. Tanning with organic products (vegetable tanning, synthetic tannins, aldehydes, resins and others) preferably occurs through the chemical reaction of amino-acids amino group that compound the protein. Protein ionic character turns to anionic charge due to the presence of free negative groups (carboxyl group) that has not reacted. The following table describes the main products during all steps of transformation of pelt into leather, the pH range that finish each step and the consequently changes in the ionic charge and in the isoelectric point drop of collagen:

TABLE 1
Relates to a flowchart of tanned pelts with chromium salts:

| | | final pH | isoeletric point and |
|---|---|---|---|
| | | in each | ionic charge of the |
| Step | Chemicals used | step | protein |
| 1 - Washing | water | 7.0 | PI = 7.5 |
| | | | ionic charge = neutral |
| 2 - Pre-skinning | None (mechanical operation) | 7.0 | PI = 7.5 |
| | | | ionic charge = neutral |
| 3 - Soak | Surfactants, Na₂CO₃ | 7.0-9.0 | PI = 7.5 |
| | | | ionic charge = anionic |
| 4 Dehairing/deliming | Sodium sulfide, lime e amines | 12.0-12.5 | PI = 5.0 |
| | | | ionic charge = anionic |
| 5 - Fleshing and split | None (mechanical operation) | 12.0-12.5 | PI = 5.0 |
| | | | ionic charge = anionic |
| 6 - Deliming or | Ammonium Sulfate, ammonium | 6.0-8.5 | PI = 5.0 |
| neutralization | chloride and organic acids | | ionic charge = anionic |
| 7 - Bate | Animal or bacterial origin | 6.0-8.5 | PI = 5.0 |
| | enzymes | | ionic charge = anionic |
| 8 - Pickling | Sulfuric acid, formic acid and | 2.5-3.5 | PI = 6.0 |
| | chloride | | ionic charge = cationic |
| 9.1 - Tanning:- | Chromium salts | 2.5-3.5 | PI = 6.0 |
| chromium salt | | | ionic charge = cationic |
| addition | | | |
| 9.2 - Tanning:- | magnesium oxyde, carbonates | 3.8-4.0 | PI = 7.0 |
| basification | | | ionic = cationic |

Presently chromium salt tanning starts in a pH range of 2.5 to 3.5 and finishes in 3.8 to 4.0. When chromium salt addition starts after pickling the pelt has an overall cationic charge. This condition allows the chromium salt dissolves in water and penetrates along all thickness of the pelt, without reacting. Reaction will take place in a second moment when alkalis are added that promote an increase in of pH value and consequently of pelt reactivity to the chromium salt. This step corresponds to step 9.2 in table 1, and it is called basification.

It is mentioned that steps from 1 to 8 are carried on when tanning is made with other tanning agents as aluminum, titanium, zirconium, iron vegetables tannins, synthetic tannins, aldehydes, resins, silicates and polyphosphates.

We can better understand the process of pelts preparation and tanning process through the example 1 below:

### EXAMPLE 1

### State of Technique

Quantity of 1000 Kg of limed pelts, 5 mm thickness:
Type of tanning: chromium sulfate tanning;
A) Neutralization/Deliming: pelt reacts with 25 Kg ammonium sulfate more 10 kg ammonium chloride for a two hours reaction time. Final pH of reaction will be about 8.0 and 9.
B) Washing of pelts with 2000 liters of water. Drain the water to the wastewater plant.
C) Enzymatic bating, pelt reaction with approximately 1.0 kg of an enzymatic solution plus 800 liters of water. Reaction is kept for 40-60 minutes. Wash pelts again for 15 minutes with 1500 to 2000 liters of water and displace the water to the wastewater treatment.
D) Pickling: It is started with addition of 500 liters of a 10% sodium chloride solution and let the system stabilize for 15 minutes. An amount of 8 kg Formic acid is added in 100 kg water for a period of 2 hours and 12 kg of sulfuric acid diluted in 120 kg of water for more two hours. Thereafter the system is kept reacting for more 4 hours to reach equilibrium, final pH is between 2.5-3.5.
E) Tanning: It is started with the addition of 60 to 70 kg of chromium III salt that contains about 25 to 27% of chromium oxyde and basicity of 33%. Reaction time is approximately 2 hours and the system is heated up to 40° C. The system is maintained for 8 hour at this temperature. The final pH of the reaction is between 3.8 to 4.0.

The objective of the present invention is the of a novel composition that can replace the steps of deliming, step 6, and pickling, step 8, described before for only one step called conditioning. The product of this invention allows preparing the pelt for tanning by means of just one product addition. The proposed system neutralizes the alkalinity and hence remove solubility of Calcium from the liming operation attached in the pelt. The action on the amino acids is strongly directed to the amino groups via Amadori reaction:

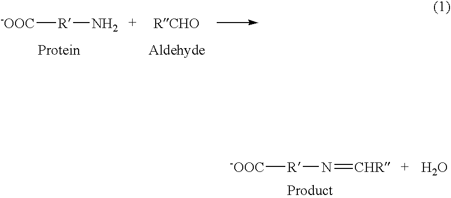

The proposed system cannot only neutralize and complex calcium but also supply the necessary acidity to start the tanning as well. Due to the action on amino group—NH₃⁺—part of protein amino acids structure, it took place the drop of isoelectric point and an increase on reactivity of the pelt to cationic products. The system in question, different of the state of the art, where tanning is started at pH values around 3, can start the same process at pH values near 5, where the pelt have high anionic character. In this value the pH of the pelt has high reactivity to cationic products (eg.: Al³⁺, Fe³⁺, Ti³⁺, Zr³⁺e Cr³⁺). Among all mentioned metals Chromium III sulfate is enhanced due to the fact that it is the most widely used for tanning.

This system permits to minimize or eliminate completely the bad features referred to the tanning operation described in the state of the art. The acidity supplied by the chromium salt dissolution is enough to low the pH value of the to the range of 3.8-4.0 needing no further addition of alkalis to accomplish the reaction. So, for chromium tanned pelts, the normally required addition of basification product can be cancelled in the new system. Another novelty of the process is the use of the system, object of present invention, to prepare pelts to alternative tanning processes, where other products can be used instead of chromium salt.

The process described in the present invention is characterized by fact of advantages in process optimization for pelt tanning, due to the replacement of 2 or 3 steps for only one step by means of addition of only 1 product. Besides the elimination of hazardous, toxic and dangerous chemicals due to the process characteristic, the new process described in the present invention provides a lesser amount of chromium salt to be used in the tanning operation step.

TABLE 2
Used products: State of the art × New proposed process

| | State of the art | | New process |
|---|---|---|---|
| Step | Chemical used | Step | Chemical used |
| 1 - Salting | NaCl | 1 - Salting | NaCl |
| 2 - Soak | Surfactants, Na₂CO₃ | 2 - Soak | Surfactants, Na₂CO₃ |
| 3 - Dehairing/Liming | Sodium sulfide, lime e | 3 - Dehairing/Liming | Sodium sulfide, lime e |
| | amines | | amines |
| 4 - Deliming | Ammonium salts | 4 - Conditioning | New Product |
| 5 - Bating | Enzymes | 5 - Bating | Enzymes |
| 6 - Pickling | NaCl, sulfuric and formic | 6 - Chrome addition | Chromium sulphate III |
| | acid | | |
| 7.a) Chrome addition | Chromium sulfate III | | |
| 7.b) Basification | Alkalis | | |
| agent addition | | | |

Table above shows that the new system can reduce the number of steps and chemicals normally used in the preparation of pelts for tanning.

The application of the system can be better understood by the steps described in example 2:

### EXAMPLE 2

### Application of the Present Invention

Quantity: 1000 Kg of limed pelts 5 mm thickness
Type of tanning: chromium sulfate salt tanning;
A) Washing: Pelts are washed with 1500 Kg water for 15 minutes in a drum. Water is drained.
B) Conditioning: It is added between 40 and 80 Kg of the conditioning product plus 300 kg of water and let it reacts for 2 to 8 hours.
C) Enzymatic bating: reaction of the pelt with approximately 1.0 kg of a non-concentrated enzymatic solution diluted in 800 liters of water and keep it reacting for 40-60 minutes. At the end the pelts are washed again with 1500 liters of water for 15 minutes in a closed drum.
D) Tanning: It is started with the addition of 50 to 60 Kg of chromium sulfate III that contains about 25 to 27% of chromium oxyde basicity 33% plus addition of 300 liters of water. Reaction time may vary between 4 and 8 hours and finishes when the Chromium has at least 80 to 100% penetration in crossed section. It is started the heating of the system until 40° C. The system is kept heated for a period of 4 to 8 hours. Final pH of the process is around 3.7 to 3.9.

Leathers produced in example 2 were submitted to chemical analysis. The results were compared to the standard reference values (table 3). The results of the float analysis of tanning bath and of the wet-blue leather produced in the example 2 (new process) are the following:

Final residual float analysis: a) pH=3.76
b) Chlorides=7.35 g/L
c) Cr₂O₃ content=1.08 g/L

TABLE 3

| | Recommended¹ (standard | Results obtained in |
|---|---|---|
| wet-blue leather analysis | reference) | example-2 |
| 1 - pH | mín. = 3.5 | 3.74 |
| 2 - Diferencial pH | máx. = 0.7 | 0.21 |
| 3 - % of Cr₂O₃ | mín. = 3.5% | 4.48% |
| 4 - % of Calcium | máx. = 0.2% | 0.12% |
| 5 - % Total ashes sulf. | máx. = 10% | 8.54% |
| 6 - Soluble in CH₂Cl₂ | máx. = 0.5% | 0.45% |
| 7 - Dermic substance | mín. = 70% | 79.47% |

¹These values are reccommended by the Technological Leather Center - SENAI - city of Estancia Velha, RS, Brazil that are according to ISO and IUC for chromium tanned leather

The composition of the system here described is obtained from functional aldehydes with the general formulation as follows:

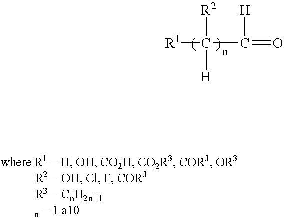

The system comprises functional aldehydes to which are added a combination or just one of the following chemicals: mono, di, tri and polycarboxylic acids; anydrides; fumaric, maleic, phthalic and anhydrides of dicarboxylic acids that contains at least 2 to 8 carbon atoms; esters of mono, di, tri and polycarboxylic acids; EDTA; boric acid and sodium and calcium tripolyphosphate.

As solvents to stabilize the system it is used one or a mixture of the following compounds: water, branched or non-branched aliphatic alcohols, glycols and polyols.

As additives it is used one or a blend of the following compounds: ammonium hydroxyde, sodium hydroxyde, sodium bicarbonate, ammonium bicarbonate and anionic or non-ionic surfactants. The system can be obtained according to the following example:

As additives it is used just one or a blend of the following compounds: ammonium hydroxide, sodium hydroxide, sodium bicarbonate, ammonium bicarbonate, anionic and non-ionic surfactants. The product of the present invention can be obtained like this:

A) It is prepared a solution of one or more compounds that belong to the group described below by the generic formulation as follows:

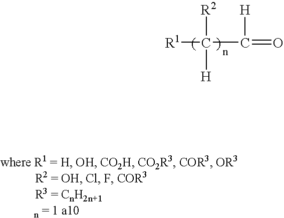

The solvent of this solution can be one or a mixture of the following solvents: water, aliphatic alcohols (branched or no branched), glycols and polyols. This solution has a concentration that can be 25 or 85% on active materials.
A) An amount of the solution prepared in A is weighed and to it is added a mixture of the following compounds: mono, di, tri and polycarboxylic acids or one of their derivatives in the form of anhydrides and esters. The proportion can vary from 10 to 80 % of the weight of original solution. As an auxiliary it can be added to the composition still 0.5 to 3.0% w/w from solution prepared in A) EDTA, sodium or calcium polyphosphates and anionic and non-ionic surfactants.

C) The system produced in B) has its pH value adjusted to values between 2.0 and 7.0 with the addition of 0.5 to 5% of one of the following products: sodium, ammonium or potassium hydroxide; sodium ammonium or potassium carbonate.

The proposed system is characterized as a viscous yellow to pale liquid with concentration of 20 to 80 %, density between 0.9 e 1.4 g/cm³ and pH between 2.0 and 7.0. It can be applied diluted or concentrated in one or more additions over the limed pelts. The amount of product to be applied, taking into account the active substance, is about 20 and 50 grams per kg of limed pelt.

1. “PRODUCT FOR PELT CONDITIONING FOR TANNING: PROCESS FOR PELT CONDITIONING AND FOLLOWING TANNING”, wherein the steps of deliming, pickling and basification in the pelts tanning process are replaced for just one step. Tanning process herein described as a process of tanning pelts using metallic salts as tanning products like chromium, aluminum, titanium, zirconium, iron, zinc, silicates.

2. “PRODUCT FOR PELT CONDITIONING FOR TANNING: PROCESS FOR PELT CONDITIONING AND FOLLOWING TANNING”, wherein the steps of deliming and pickling in the pelts tanning process are replaced for just one step. Tanning process herein described as a process of tanning pelts using the following tanning products: vegetables tannins, synthetic tannins, lignosulphonates, aldehydes, resins and polyphosphates.

3. “PRODUCT FOR PELT CONDITIONING FOR TANNING: PROCESS FOR PELT CONDITIONING AND FOLLOWING TANNING”, wherein only the proposed system described herein can be used for the process of conditioning limed pelts for tanning in just one step.

4. “PRODUCT FOR PELT CONDITIONING FOR TANNING: PROCESS FOR PELT CONDITIONING AND FOLLOWING TANNING”, according to claim 3 wherein for the process of conditioning limed pelts for tanning in just one step, only the proposed new product can be used, in a single dosage or multiple dosage, pure or diluted in water in a proportion of 1:0 to 1:15 and applying a quantity of 20 to 60 grams of the product per kg of limed pelts as a preparation for tanning.

5. “PRODUCT FOR PELT CONDITIONING FOR TANNING: PROCESS FOR PELT CONDITIONING AND FOLLOWING TANNING”, wherein the product herein described is prepared as a composition of one or more modified aldehydes that belong to the group described below by the generic formulation as follows: 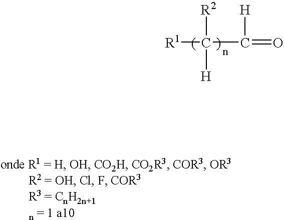
mixed with a combination or just one of the following chemicals: mono, di, tri and polycarboxilic acids; anhydrides: fumaric, maleic and ftalic anhydrides of dicarboxilic acids that contains at least 2 to 8 carbon atoms; esters of mono, di, tri and polycarboxilic acids; EDTA; boric acid and sodium and calcium tripolyphosphates cálcio.

6. “PRODUCT FOR PELT CONDITIONING FOR TANNING: PROCESS FOR PELT CONDITIONING AND FOLLOWING TANNING”, wherein the solvent to stabilize this solution can be one or a mixture of the following solvents: water, aliphatic alcohols (branched or no branched), glycols and polyols.

7. “PRODUCT FOR PELT CONDITIONING FOR TANNING: PROCESS FOR PELT CONDITIONING AND FOLLOWING TANNING”, wherein apart from the compounds mentioned before, it can be used as additives alternatively one or a blend of the following compounds: ammonium hydroxide, sodium hydroxide, sodium bicarbonate, ammonium bicarbonate and anionic or non-ionic surfactants.

8. “PRODUCT FOR PELT CONDITIONING FOR TANNING: PROCESS FOR PELT CONDITIONING AND FOLLOWING TANNING”, wherein the resulting product is a viscous yellow to pale liquid with concentration of 20 to 80%, density between 0.9 e 1.4 g/cm³ and pH between 2.0 and 7.0
